(19) United States
(12) Patent Application Publication
(10) Pub. No.: US 2018/0222151 A1
(43) Pub. Date: Aug. 9, 2018

(54) Aluminium composite material for use in thermal flux-free joining methods and method for producing same

(71) Applicants: Kathrin Eckhard, Alfter (DE); Olaf Güssgen, Koln (DE); Thorsten Richter, Niederkassel (DE); Hartmut Janssen, Hilden (DE); Nico Eigen, Hamburg (DE)

(72) Inventors: Kathrin Eckhard, Alfter (DE); Olaf Güssgen, Koln (DE); Thorsten Richter, Niederkassel (DE); Hartmut Janssen, Hilden (DE); Nico Eigen, Hamburg (DE)

(73) Assignee: Hydro Aluminium Rolled Products GmbH, Grevenbroich (DE)

(21) Appl. No.: 15/945,897

(22) Filed: Apr. 5, 2018

Related U.S. Application Data
(63) Continuation of application No. PCT/EP2016/073667, filed on Oct. 4, 2016.

(30) Foreign Application Priority Data
Oct. 5, 2015 (EP) 15188424.4

(51) Int. Cl. B32B 15/01; B32B 38/10; B32B 38/18; B32B 37/04

(52) U.S. Cl. CPC B32B 15/016; B32B 38/10; C22C 21/06; B32B 37/04; B32B 2310/0418; B32B 38/1858

(57) ABSTRACT

Provided are embodiments of an aluminium composite material for use in thermal flux-free joining methods. The composite material has at least one core layer of an aluminium core alloy and at least one outer solder layer of an aluminium solder alloy. The aluminium solder alloy has the following composition in wt %: 6.5%≤Si≤13%, Fe≤1%, 230 ppm≤Mg≤450 ppm, Bi≤500 ppm, Mn≤0.15%, Cu≤0.3%, Zn≤3%, and Ti≤0.30% with the remainder Al and unavoidable impurities individually at most 0.05%, in total at most 0.15% and the aluminium solder layer has an alkaline pickled or acid pickled surface. The invention further relates to a method for producing an aluminium composite material, a method for the thermal joining of components, and a thermally joined construction.

### CROSS-REFERENCE TO RELATED PATENT APPLICATIONS

This patent application is a continuation of PCT/EP2016/073667, filed Oct. 4, 2016, which claims priority to European Application No. 15188424.4, filed Oct. 5, 2015, the entire teachings and disclosure of which are incorporated herein by reference thereto.

### FIELD OF THE INVENTION

The invention relates to an aluminium composite material for use in thermal flux-free joining methods, comprising at least one core layer consisting of an aluminium core alloy and at least one outer solder layer provided on one or both sides of the core layer consisting of an aluminium solder alloy. The invention further relates to a method for producing an aluminium composite material, in particular an aluminium composite material according to the invention in which at least one core layer consisting of an aluminium core alloy is provided and at least one outer solder layer consisting of an aluminium solder alloy is applied on one or both sides of the core layer. The invention further relates to a method for thermally joining components as well as a thermally joined construction.

### BACKGROUND OF THE INVENTION

Aluminium composite materials with at least one core layer consisting of an aluminium core alloy and at least one outer solder layer provided on one or both sides of the core layer are used for producing soldered constructions. The soldered constructions often have a plurality of solder points, as is the case for example with heat exchangers. In this case, different soldering methods are used to solder metal components.

One of the most common methods is the controlled atmosphere brazing (CAB) method in which the aluminium components are generally soldered using fluxing agents and are exposed during the soldering operation to an inert gas atmosphere for example to a nitrogen atmosphere. Other thermal joining methods also use fluxing agents and also soften the aluminium solder in the presence of a protective gas. However, the use of corrosive or non-corrosive fluxing agents poses disadvantages, for example increased installation costs and technical problems during the interaction of remainders of the fluxing agent with for example coolant additives in a heat exchanger. Furthermore, the use of fluxing agents is also problematic in relation to avoiding environmental impacts and from occupational safety points of view. Lastly, in the CAB method, the use of Mg-containing solder alloys is problematic since magnesium negatively influences the solder properties under a protective gas atmosphere. Magnesium interacts strongly with the fluxing agent, which is why said fluxing agent can no longer carry out its actual function and in the case of larger quantities of Mg soldering ultimately can no longer be carried out. The reaction products also encrust the soldering sleeves which then have to be replaced more frequently. Pores may also occur in the soldering fillet or discolorations of the soldered components may occur.

The second method, which is widely used, is vacuum soldering in which the components to be soldered are soldered in an atmosphere with very low pressure, for example roughly 10⁻⁵ mbar or less. Vacuum soldering can be carried out without fluxing agents. For this reason, it can be assumed with vacuum-soldered components that they have a very high degree of cleanliness of the surfaces following the soldering process. The solder quality of components from this method is usually very high.

However, vacuum soldering installations are very costly both in terms of investment and also operation. The throughput performance is also significantly lower in comparison to protective gas soldering.

In vacuum soldering, however, the solder quality could be reduced as a result of residual gases and impurities in the atmosphere of the solder furnace reacting with the solder layer. The solder layer also has an oxide layer on the surface which can reduce the wetting properties of the solder. To improve the solder quality, a determined proportion of magnesium is thus generally added to the aluminium solder in order to obtain an improved solder result. The magnesium in the solder layer already starts to evaporate below the melting temperature of the solder, whereby the oxide layer present is disrupted in a manner conducive to soldering. When the solder layer is melted, the evaporating Mg can thus reduce the negative effect of the oxide layer on the surface of the melt. Furthermore, the evaporated magnesium functions as a getter material and for example reacts with oxygen and water in the atmosphere of the furnace. Such residual gases can thus be kept away from the solder layer.

In the textbook, Schweitßen und Hartlöten von Aluminiumwerkstoffen by H. Schoer, DVS Media Verlag (2003), it is described that Mg contents were initially 2-3% in vacuum soldering. Through later developments in vacuum soldering, the Mg content of the solder alloys could be reduced to up to 1.2%. Vacuum soldering is only possible under this Mg content when the other alloys in the material have a correspondingly noticeably higher Mg content.

In generally, solder alloys with a relative high Mg content are thus used in vacuum soldering. These solder alloys with an Mg content of at least 1.0 wt % Mg are usually of type AA 4004 or AA 4104.

However, the disadvantage of this usually used high Mg content is that the condensate of the evaporated Mg is deposited as a residue in the furnaces. As a result, the furnaces have to be expensively cleaned at shorter intervals to remove resulting residues. This causes additional costs and reduces the productivity of the furnace installation.

A flux-free alternative to the CAB method is thus provided by vacuum soldering, however, vacuum soldering is very complex in terms of equipment and thus very cost-intensive. The material selection was also previously limited due to the requirements of a higher Mg content. Use in a determined thermal joining method is thus already also usually predefined due to the composition of the materials. Solder alloys with low Mg contents are in particular used in the CAB method using fluxing agents, however, they were previously hardly suitable for reliable and economic joining in the vacuum soldering method. Solder alloys with higher Mg contents, roughly from 1.0 wt % Mg can be used in the vacuum with good solder results, but are entirely unsuitable for the CAB method. The user of a material is thus often already fixed to a determined joining method with the composition of a solder layer in a material or a component.

The use of an alkaline pickled aluminium composite material in a vacuum soldering method or with fluxing agents in a CAB soldering method is known from the Japanese publications JP 04-1000696, JP 04-100674 and JP 05-154693.

A method for flux-free soldering with the CAB soldering method is also known from the international patent application WO 2010/000666 A1 in which the aluminium solder layer consists of a first aluminium solder layer and a second aluminium solder layer. The second aluminium solder layer consists of an Al—Si aluminium alloy which, in addition to 5 wt %-20 wt % silicone, also contains 0.01 wt %-3 wt % magnesium. The first aluminium solder layer, in contrast, contains 2 wt %-14 wt % silicone and less than 0.4 wt % magnesium. The two-layer structure of the aluminium solder layer is, however, disadvantageous insofar as that during production of the two-layer aluminium solder layer, higher costs are incurred. Furthermore, a significant disadvantage of conventional two-layer structures for example with an outer cladding of pure aluminium may be that its use is not compatible with fluxing agents. Insufficient solder results, for example due to temporarily poorer furnace atmosphere with excessive oxygen partial pressure or excessive moisture in the atmosphere may not be optionally compensated by the use of fluxing agents.

The US patent document U.S. Pat. No. 5,102,033, in contrast, describes a method in which an aluminium composite material consisting of an aluminium core alloy and an aluminium solder alloy layer with an acid pickling solution, which contains a mixture of nitric acid and hydrofluoric acid, is pickled and then soldered by vacuum soldering. The US document also mentions conventional soldering methods. However, these are generally, insofar as they are not carried out in a vacuum, characterised by the use of fluxing agents.

The separate published WO 2013/164466 A1 discloses the principle of using an acid or alkaline pickled aluminium composite material in a flux-free thermal joining method.

Against this background, the object of the present invention is to propose an aluminium composite material for use in thermal flux-free joining methods by means of which the solder properties can be further optimised without using fluxing agents while avoiding the disadvantages known from the state of the art and the same aluminium composite material can also be joined reliably in the different soldering methods, in particular both in a vacuum and under protective gas. A method for producing an aluminium composite material, a method for thermally joining components and a thermally joined construction are also indicated for this purpose.

### BRIEF SUMMARY OF THE INVENTION

According to a first teaching, the mentioned object concerning an aluminium composite material is achieved in that the aluminium solder alloy has the following composition in wt %
6.5%≤Si≤13%,
Fe≤1%,
230 ppm≤Mg≤450 ppm,
Bi<500 ppm,
Mn≤0.15%,
Cu≤0.3%,
Zn≤3%,
Ti≤0.30%,
   Remainder Al and unavoidable impurities individually at most 0.05%, in total at most 0.15% and the aluminium solder layer has an alkaline pickled or acid pickled surface.

By means of the above-mentioned specification of the Si content of the aluminium solder alloy, said alloy can have a lower melting point than the aluminium core alloy such that when the component to be soldered is heated to a temperature below the solidus temperature of the aluminium core alloy, the aluminium solder layer is fluid or partly fluid. The aluminium core alloy, in contrast, does not melt.

The Si contents of the aluminium solder alloy are preferably at least 6.5 wt % to at most 12 wt %, particularly preferably at least 6.8 wt % to at most 11 wt %. By delimiting the maximum Si content, disadvantageous effects can be avoided during thermal joining, for example erosion through diffusion of Si into the joined component.

Through the special and unique combination of an alkaline pickled or acid pickled surface with the above-mentioned range of the Mg content, the aluminium composite material can be used in a flux-free manner in a thermal joining method and in this case outstanding solder results can be achieved. This applies both in vacuum soldering methods and for flux-free thermal joining under a protective gas atmosphere, for example in a CAB method which usually cannot be carried out without fluxing agents or only in a very limited manner. Using the aluminium composite material, the use of fluxing agents, which is demanding and cost-intensive in terms of safety and production, can be dispensed with even in the case of high requirements on the quality of the solder connection. Surprisingly, it has been found that this specially set Mg content is already sufficient in combination with an alkaline or acid pickle to enable thermal joining under a vacuum which was otherwise only known of solder alloys with Mg contents of more than 1%.

It has been found that very good solder results in flux-free joining (CAB method) can also be achieved with an Mg content of at most 450 ppm. The mentioned Mg content is, on the one hand, low enough to at least stem the known disadvantages of an excessive Mg content, for example that the quality of the solder connection is deteriorated in the CAB method, that discolorations of the surface occur and that devices for thermal joining with Mg compounds are soiled.

On the other hand, with an Mg content of at least 230 ppm, process-reliable and dependable soldering can already be achieved; in particular even for small absolute quantities of solder, for example thin solder layers and/or low Mg contents of the aluminium core alloy. The minimum content for Mg thus enables the solder capacity to be ensured in a flux-free manner largely irrespective of the thickness of the core layer and the type of aluminium core alloy as well as the thickness of the solder layer in different joining methods. Both thick and thin core layers, and aluminium core alloys with low or high Mg contents can be used in the aluminium composite material.

Using the described aluminium composite alloy, it is thus possible for components, which could previously only be soldered in a vacuum due to high demands for cleanliness of the surface and the stability of the solder connection, to now also be joined in a flux-free, cost-effective CAB method. The user of the aluminium composite material can, if required or based on the available production capacities, in particular also select which method for thermal joining is used without the specification or the surface of the aluminium composite material having to be changed.

Bi can reduce the surface tension and the flow behaviour of the melted aluminium solder alloy and thus improve the solder properties. It has been found that a Bi content of up to 500 ppm further optimises the solder properties in connection with the above-mentioned specifications on Si content and Mg content as well as the alkaline pickled or acid pickled surface. Bi is preferably added to the aluminium solder alloy in a targeted manner in the mentioned concentration range.

Fe is usually contained as an impurity or also as an additive in aluminium alloys. The Fe content of the aluminium solder alloy is at most 1 wt %, preferably at most 0.8 wt %. Mn and Cu are also often found as an impurity, alloy element or minor additive in aluminium alloys, the aluminium solder alloy having at most a Mn content of 0.15 wt % and a Cu content of at most 0.3 wt %. Ti can be included as an impurity or additive for the purpose of grain refinement, the Ti content of the aluminium solder alloy being at most 0.30 wt %.

The Zn content of the aluminium alloy is limited to at most 3 wt %, preferably at most 1.2 wt %. Zn can be provided as an additional alloy element to reduce the electrochemical potential of the solder alloy in comparison to other regions of the material or of the component to be produced and to promote the corrosion protection of these other regions. To reduce the electrochemical potential, a Zn content of at least 0.8 wt % to at most 3 wt %, preferably to at most 1.2 wt % is preferably provided in the aluminium solder alloy.

Higher Zn contents, generally speaking, increase the susceptibility to corrosion of the aluminium solder alloy. If a reduction of the electrochemical potential of the solder alloy is not required or not desired, the Zn content can be restricted to lower contents. The Zn content is preferably at most 0.2 wt %, preferably at most 0.1 wt % or as an impurity at most 0.05 wt % in order to improve the susceptibility to corrosion of the aluminium solder alloy.

The aluminium solder alloy has, in one configuration of the aluminium composite material, an Mg content in wt % of
230 ppm≤Mg≤400 ppm.

By additionally limiting the maximum content of Mg, the negative effects of the Mg content, for example problems during use in the CAB method, can be further contained. The Mg content in the aluminium solder alloy can for this purpose also have a content in wt % of
250 ppm≤Mg≤350 ppm
   in order to also limit the negative effects of the Mg content. With a higher minimum content of Mg of 250 ppm, in particular of 300 ppm, the solder properties are also improved. However, in this range, the solder properties of a pickled surface of the aluminium composite material remain so good that different aluminium core alloys can be reliably soldered even with low Mg contents and low absolute quantities of solder.

According to a further configuration of the aluminium composite material, the aluminium solder alloy has a Bi content in wt % of
Bi≤280 ppm,
   Corresponding Bi contents are already sufficient to largely optimise the solder properties of the aluminium composite material without larger quantities of Bi having to be added.

In order to improve the solder results, the Bi content of the aluminium solder alloy in wt % is
100 ppm≤Bi≤280 ppm, in particular
200 ppm≤Bi≤280 ppm.

In particular, through corresponding additions of Bi, the solder capacity is further increased. The minimum contents of Bi are preferably combined with an alkaline pickled surface. It has been found that the advantageous effect of Bi in the aluminium solder alloy is supported in a particular manner by an alkaline pickled surface.

Furthermore, it has been found that additions of Bi can also partially contain the effect of the Mg content which contributes to a solder capacity both in a vacuum and under protective gas. It is assumed that additions of Bi enter an intermetallic phase with Mg, for example Mg₃Bi₂, by means of which a part of the Mg content is bonded. It may thus be advantageous for the limit values of the range of the Mg content to be raised if more than 100 ppm or above 200 ppm Bi are present in the aluminium solder alloy. In particular the previously-described minimum values of the Mg content of the aluminium solder alloy can be raised by 50 ppm, in particular 70 ppm. It is also conceivable for the previously-described maximum values of the Mg content of the aluminium solder alloy to be raised by 50 ppm, in particular 70 ppm.

According to an alternative configuration of the aluminium composite material, the Bi content of the aluminium solder alloy is limited to at most 50 ppm. In particular, Bi is then only present as an impurity in the aluminium solder alloy. Due to the good solder properties, which are already justified by the above-mentioned combination of the Mg content with the surface treatment, the addition of Bi can be dispensed with by using this limitation.

In a further preferred configuration of the aluminium composite material, the aluminium solder alloy meets for example the specifications of the type AA 4045 or type AA 4343. With this restriction to the types AA 4343 and AA 4045, the solder layer of the aluminium composite material can be provided with a targeted selection from standard solder alloys by carrying out the targeted selection and combination of the Mg content within this alloy specification and with the alkaline pickled or acid pickled surface.

The alloy composition of the type AA 4343 preferably has the following alloy elements in wt %:
6.8%≤Si≤8.2%,
   Fe≤0.8%,
230 ppm≤Mg≤450 ppm,
   Cu≤0.25%
   Mn≤0.10%
   Zn≤0.20%
      Remainder Al and unavoidable impurities individually at most 0.05%, in total at most 0.15%.

The alloy composition of type AA 4045 preferably has the following alloy elements in wt %:
9.0%≤Si≤11.0%
   Fe≤0.8%,
230 ppm≤Mg≤450 ppm,
   Cu≤0.30%,
   Mn≤0.05%,
   Zn≤0.10%,
   Ti≤0.20%,
      Remainder Al and unavoidable impurities individually at most 0.05%, in total at most 0.15%.

An additional Zn content up to at most 3 wt % can optionally also be provided to reduce the electrochemical potential in deviation from the types AA 4343 and AA 4045. The Zn content is, to this end, preferably 0.8 wt %-1.2 wt %.

The aluminium composite material is for example further improved by an aluminium alloy of the type AA1xxx, AA2xxx, AA3xxx, AA5xxx or AA6xx being provided as the aluminium core alloy. The Mg content in the indicated aluminium core alloys can be at most 1.0 wt %, preferably at most 0.8 wt %. Due to the aluminium core alloys that can now be used in thermal joining under protective gas, in particular even Mg-containing aluminium core alloys, the spectrum of the use areas of soldered constructions has become notably wider. For example Mg-containing aluminium alloys that are difficult to solder, such as for example of the alloy type AA5xxx or AA6xxx with an Mg content of at most 1.0 wt %-0.8 wt % can be joined according to a further configuration in a flux-free, thermal joining method under protective gas (CAB). It has for example been found that composite materials according to the invention with an aluminium core alloy of type AA6063 or type AA6060 also achieve very good solder results both in a vacuum and in CAB soldering.

In one configuration of the aluminium composite material, the aluminium core alloy meets the specifications of the type AA3xxx. Aluminium core alloys of this type are used with different Mg contents. A preferred variety of this type has an Mg content of at least 0.2 wt % to at most 1.0 wt % or at most 0.8 wt % or preferably 0.2 wt %-0.6 wt %. It has higher strengths due to the higher Mg content. An example of a corresponding AA3xxx alloy is the alloy of type AA3005.

Since a fluxing agent in the aluminium composite material according to the invention in the CAB method no longer has to be used, all above-mentioned, magnesium-containing alloy types can also be soldered without an intermediate cladding acting as a magnesium diffusion barrier in the CAB method.

The aluminium core alloy, in particular an AA3xxx aluminium core alloy, can also have an Mg content in wt % of
500 ppm≤Mg≤0.30%
   AA3xxx core alloys with these Mg contents are widely popular and are used in different applications. Depending on the selected soldering method, they had to previously be produced with different solders, which are customised to the vacuum or the CAB method. Now a single combination of aluminium solder and aluminium core alloy can be used in many applications and the production costs are reduced. This can also significantly improve the recycling capacity of the soldered components.

Particularly preferred alloys with these Mg contents are the aluminium alloys of the type AA 3003 or the type AA 3017. The indicated aluminium core alloys are in particular used for use in the automobile sector, for example for the construction of heat exchangers.

The solder capacity of the aluminium composite material remains unaffected, even when the Mg content of the aluminium core alloy is at most 0.1 wt %, preferably at most 0.05 wt % or less than 0.05 wt %. Aluminium composite materials with the specific combination of Mg content of the aluminium solder alloy and an acid or alkaline pickled surface thus also allow reliable processing of aluminium core alloys with very low Mg contents. The Mg content of the aluminium core alloy can even be limited to at most 250 ppm or at most 100 ppm. Even magnesium-free aluminium core alloys can be soldered satisfactorily.

According to a further configuration of the aluminium composite material, the aluminium core alloy preferably has one of the following compositions:
0.25%≤Cu≤0.60%
0.25%≤Fe≤0.4%
   Mg≤0.10%
0.9%≤Mn≤1.5%
   Si≤0.25%
   Ti≤0.25%
   Zn≤0.10%
   Cr≤0.15%
      Remainder Al and impurities individually ≤0.05%, in total ≤0.15%
      or
0.1%≤Cu≤0.6%,
   Fe≤0.7%,
0.2%≤Mg≤0.60%,
1.0%≤Mn≤1.6%,
   Si≤0.7%,
   Ti≤0.10%,
   Zn≤0.25%,
   Cr≤0.1%,
      Remainder Al and unavoidable individually ≤0.05%, in total ≤0.15%
      or
0.2%≤Cu≤0.8%,
   Fe≤0.7%,
   Mg≤0.30%,
1.0%≤Mn≤1.5%,
   Si≤0.6%,
   Zn≤0.10%,
      Remainder Al and impurities individually ≤0.05%, in total ≤0.15%.

The mentioned aluminium alloys have, due to increased Cu contents, improved strengths with improved corrosion resistance due to an increased electrochemical potential. They are also preferably used for producing parts of heat exchangers and significantly benefit from the flexible design of the usable soldering method since, as already mentioned, an aluminium composite material according to the invention with correspondingly prepared surface can be used both in the CAB method without fluxing agents and in the vacuum soldering method.

Further variants have the following composition:
Cu≤0.2%
Fe≤0.7%
Mg≤0.10%
1.0%≤Mn≤1.7%
Si≤1%
0.4%≤Zn≤1.5%, preferably 1.1≤Zn≤1.5%
   Remainder Al and impurities individually ≤0.05%, in total ≤0.15%
   or
Cu≤0.10%
Fe≤0.7%
Mg≤0.4%
1.0%≤Mn≤1.5%
Si≤0.8%
Zn≤0.10%
   Remainder Al and impurities individually ≤0.05%, in total ≤0.15%.

Different aluminium core alloys are usually used for different parts, in a heat exchanger for example for headers, fins and pipes. Due to the reduced copper content of both aluminium alloys, the differences in the electrochemical potential to the different materials of the same component can be kept low when using the previously-mentioned aluminium core alloys. The previously-mentioned aluminium alloy is thus preferably used for the headers of a heat exchanger.

In one configuration of the aluminium composite material, the aluminium composite material is present in strip form and is in particular produced by roll cladding or simultaneously casting. As a result, an aluminium composite material is provided that can be produced on an economically large scale, in particular by producing the aluminium composite by simultaneous casting or roll cladding. Alternatively to the simultaneously casting or roll cladding, it is also possible to apply the aluminium solder layer by thermal spraying. However, the first-mentioned variations are the methods for producing an aluminium composite material currently used for large industrial scope, the casted material being distinguished by its clear concentration gradients between the different aluminium alloy layers from the discreet layer compositions of the roll-clad material. Only low diffusion processes take place between the layers with roll cladding.

According to a subsequent configuration of the aluminium composite material, the aluminium composite material has been soft-annealed, partially annealed or solution-annealed. By soft-annealing, partial annealing or solution-annealing, the mechanical properties of the aluminium composite material, in particular of the core layer can be set corresponding to the provided use area.

The aluminium composite material preferably has, according to a further configuration, an average thickness of 0.05-6 mm and further preferably of 0.2-3 mm or 0.5 mm-1.5 mm. With these thickness ranges, a wide spectrum of applications, in particular even in the range of heat exchangers, can also be covered.

In a further configuration of the aluminium composite material, the at least one solder layer has an average thickness which is from 2%-20%, in particular from 5%-10% of the average thickness of the aluminium composite material. The at least one solder layer can in particular have an average thickness of at least 20 μm. It has been found that with suitable component geometry, a correspondingly thick solder layer achieves particularly reliably good solder results and generally sufficient quality of the solder connection. The solder layer can also have an average thickness of at least 30 μm, in particular of at least 100 μm. These thicknesses enable improved solder properties of the aluminium solder alloy due to the absolute solder quantities associated therewith. The corresponding thicknesses are in particular optimised with respect to the Mg contents of the aluminium solder alloy.

According to a further teaching, the above-mentioned task concerning a method for producing an aluminium composite material, in particular a previously-described aluminium composite material is achieved in that the aluminium solder alloy has the following composition in wt %:
6.5%≤Si≤13%,
   Fe≤1%,
230 ppm Mg_450 ppm,
   Bi≤500 ppm,
   Mn≤0.15%,
   Cu≤0.3%,
   Zn≤3%,
   Ti≤0.30%,
      Remainder Al and unavoidable impurities individually at most ≤0.05%, in total at most ≤0.15% and the aluminium composite material is pickled with an aqueous, alkaline or acid pickling solution.

As already mentioned regarding the previously-described aluminium composite material, the specific and unique combination of an alkaline pickled or acid pickled surface with the above-mentioned narrow range of the Mg content enables the aluminium composite material to be used in a flux-free manner in a thermal joining method and in this case outstanding solder results can be achieved. This also applies to flux-free thermal joining within a protective atmosphere, for example in a CAB method, which usually cannot be carried out without fluxing agent or only in a very limited manner. Using the aluminium composite material, the use of fluxing agents, which is demanding and cost-intensive in terms of safety and production, can be dispensed with even in the case of high requirements on the quality of the solder connection.

According to a subsequent configuration of the method, the surface of the aluminium solder layer is pickled with an acid, aqueous pickling solution containing at least one mineral acid and at least one complexing agent or at least one acid of the group of short-chain carboxylic acids and at least one complexing agent or a complexing acid.

Preferably, according to a further embodiment, H₂SO₄ with 0.1%-20 wt %, H₃PO₄ with 0.1%-20 wt %, HCl with 0.1%-10 wt % as well as HF with 20 ppm-3% or a combination of the mineral acids are for example used as mineral acids. HF with 20 ppm-3 wt %, 20 ppm-1000 ppm or 20 ppm-600 ppm, particularly preferably 300 ppm-600 ppm or 300 ppm-480 ppm as well as H₃PO₄ with 0.1%-20 wt % are used as complexing mineral acids. A particularly preferred combination consists of H₂SO₄ with 0.5%-2.5 wt % and HF with 20 ppm and 480 ppm.

Formic acid is preferably used as short-chain carboxylic acid. Fluorides with 20 ppm-3 wt %, preferably 20 ppm-1000 ppm or 20 ppm-600 ppm particularly preferably 300 ppm-600 ppm or 300 ppm-480 ppm are for example used as complexing agents. In the tests, it has in particular been shown that when using fluorides, a concentration of at most 300 ppm-600 ppm, preferably 300 ppm-480 ppm is sufficient to enable a quick surface treatment in an industrial environment.

Fluorides, citrates, oxalates or phosphates can be used as complexing agents.

By pickling the aluminium solder layer using a mineral acid or at least one acid of the group of short-chain carboxylic acids in combination with a complexing agent or using complexing acids, a surface quality of the aluminium solder layer can be achieved such that in a thermal joining method in the absence of oxygen it has further optimised, outstanding solder properties or properties for thermal joining without requiring fluxing agents.

According to a further configuration of the method, the concentrations of the mineral acid in the pickling solution have the following limits:
H₄SO₄: 0.1%-20 wt %
H₃PO₄: 0.1%-20 wt %
HCl: 0.1%-10 wt %
HF: 20 ppm-3 wt %

Higher concentrations are not desirable for economic or ecological reasons, irrespective of their technical implementability. Furthermore, it was found that a combination of the mineral acids H₄SO₄ and HF in the above-mentioned concentrations achieve particularly good solder results. A particularly preferred combination consists of H₄SO₄ with 0.5%-2.5 wt % and HF preferably 20 ppm-1000 ppm or 20 ppm-600 ppm, particularly preferably 300 ppm-600 ppm or 300 ppm-480 ppm.

At least one surfactant is optionally provided in the aqueous pickling solution in order to simultaneously degrease the surface of the aluminium composite material and to increase the evenness and speed of the pickling action of the pickling solution.

The mentioned concentrations of mineral acids allow the surface of the aluminium solder alloy layer to be attacked by reducing the pH value. The complexing agents ensure that dissolved alloy constituents are very water-soluble with the mentioned concentrations of mineral acids and in this respect can be removed from the reaction location. Possible organic deposits are removed from the surface by the optionally present surfactants and degreasing of the aluminium strip layer is achieved. This has the consequence that the pickling attack cannot be inhibited locally by organic surface deposits and thus takes place with greater evenness.

According to a further configuration of the method, the pickling solution also contains HNO₃. The effectiveness of HF through the combination with nitric acid and further mineral acids can be further increased such that an improved solder result is achieved with a low HF use. The concentration of HNO₃ is preferably 0.1 wt %-20 wt %.

In one configuration of the aluminium composite material, the pickled surface of the aluminium solder layer has been pickled by pickling with an alkaline pickling solution containing 0.01-5 wt % NaOH, preferably 0.2-5 wt % NaOH. It has been found that using the mentioned concentrations, sufficient pickling of the surface of the solder layer can be carried out such that an aluminium composite material for flux-free soldering can be easily provided.

A complexing agent can preferably be added to the alkaline pickle. The solder result is hereby further improved. If a complexing agent-containing degreasing medium is added to the alkaline pickle, degreasing can also take place. For example, a pickling solution comprising the following constituents is used: at least 0.5-3 wt % of an aqueous mixture of 5-40 wt % sodium tripolyphosphate, 3-10 wt % sodium gluconate, 3-8 wt % non-ionic and anionic surfactants, optionally 0.5-70 wt % sodium carbonate, adding NaOH, the concentration of NaOH in the pickling solution being in total 0.01-5 wt %. The concentration of NaOH in the pickling solution is further preferably in total 0.2-5 wt %. Using such a pickling solution, the surface of the aluminium composite material can be particularly reliably conditioned.

According to one configuration, the aluminium composite material is preferably degreased prior to pickling or during the pickling with a degreasing medium. The degreasing prior to pickling can also take place by annealing, while the degreasing during the pickling takes place preferably with a degreasing medium.

In a further configuration of the method, the aluminium composite material previously treated by means of alkaline pickling is subjected to deoxidation. An acid solution is preferably used for this purpose. A solution containing 1-10% nitric acid is suitable for example. Deoxidation has been found to be advantageous in particular in connection with an alkaline pickle.

Deoxidation can optionally also be carried out by adding fluorides with a maximum content of 1000 ppm fluoride, preferably 200-600 ppm fluoride in the deoxidation. Using the corresponding contents, an improvement of the solder capacity can be achieved. The deoxidation with fluorides is in particular advantageous with lower Mg contents of about 230 ppm to 350 ppm or 300 ppm to further promote solder capacity.

If the stay or contact time of the aluminium composite material with the pickling solution is 1-60 seconds, preferably 2-40 seconds, an economically implementable surface treatment step can be provided in which an entire aluminium strip is for example surface-treated.

For alkaline pickling, the contact time is further preferably 2-30 seconds. For acid pickling, the contact is further preferably 2-20 seconds. The contact times produce good surface conditioning and are suitable for economic production.

In a further configuration of the method, the pickling treatment is carried out in a spraying process. Using the method according to the invention or the specific pickling treatment, the conditioning with a spraying process to increase the production speed, is also possible for example with treatment directly on a running strip. The use of a dip process is also conceivable.

The stay or contact time can be further reduced if the temperature of the pickling solution is 40° C.-85° C. since the reactivity of the reagents is further increased hereby. Temperatures above 85° C. require additional measures with no clear gain in processing speed. A preferred temperature range is thus 50° C.-60° C.

According to a further teaching, the above-mentioned object concerning a method for thermal joining of components of at least one aluminium alloy in which at least one component comprising an above-described aluminium composite material is thermally joined in a flux-free manner to at least one further component. In particular, the at least one further component comprises aluminium or an aluminium alloy.

The combination of an alkaline pickled or acid pickled surface with the narrow range of Mg content in the solder layer of the aluminium composite material ensures that thermal joining methods can be carried out in a flux-free manner and outstanding solder results can be achieved. Using the aluminium composite material, the use of fluxing agents, which is demanding and cost-intensive in terms of safety and production, can be dispensed with even in the case of high requirements on the quality of the solder connection.

In this case, solder alloys according to the invention, in particular of the type AA 4343 or AA 4045 with 230 ppm to 450 ppm of magnesium are used which are usually at least not suitable for the vacuum process due to the Mg content which is too low by multiple orders of magnitude. By the combination of an alkaline pickled or acid pickled surface with the composition of the aluminium composite material, in particular with matched Mg content of the aluminium solder alloy, it is inter alia achieved that thermal joining methods can be carried out in a vacuum even with such solder alloys with low Mg contents.

In one configuration of the method, the flux-free thermal joining is carried out in the vacuum in particular with a maximum pressure of 10⁻⁵ mbar. The vacuum soldering can be carried out without fluxing agents and the negative effects of a high Mg content can also be avoided by the composition of the solder layer. In particular, the deposits of Mg compounds in a furnace for thermal joining can be largely avoided, which means that frequent cleaning intervals of the furnace are no longer required.

According to a subsequent configuration, the flux-free thermal joining is carried out in a protective gas atmosphere. For example, the thermal joining can be carried out by means of a CAB method. The use of a protective gas atmosphere is less complex in terms of equipment in comparison to vacuum soldering.

According to a further teaching, the above-mentioned object concerning a thermally joined construction is achieved with at least one component comprising an above-described aluminium composite material and at least one further component which in particular comprises aluminium or an aluminium alloy. The thermally joined construction can in particular be obtained with a previously-described method for thermal joining. Such a thermally joined construction may have outstanding solder quality, wherein no fluxing agent residues remain on the surface due to the dispensation with fluxing agents during the thermal joining. The disadvantages of a high Mg content are also avoided, for example discolouration or the surface.

With regard to further configurations and advantages of the method for producing an aluminium composite material, of the method for thermal joining and the thermally joined construction, reference is made to the above embodiments of the aluminium composite material and the following description of the drawing.

### BRIEF DESCRIPTION OF THE SEVERAL VIEWS OF THE DRAWING

In the drawing is shown in:

FIG. 1 shows a perspective representation of the solder test geometry for determining the solder capacities of the aluminium composite materials;

FIG. 2 shows a side view of the soldering test geometry;

FIG. 3a-c show overview diagrams of the solder results of different exemplary embodiments of the aluminium composite material with pickled surface as a function of the Mg contents of aluminium solder alloy and aluminium core alloy in the CAB method;

FIG. 4a-c show photos of a soldered exemplary embodiment of the aluminium composite material in the CAB method;

FIG. 5a, b show cuts of the solder points of exemplary embodiments of the aluminium composite material in a vacuum soldering method;

FIG. 6 shows a schematic sectional view of an exemplary embodiment of a method for producing a strip-shaped aluminium composite material; and

FIG. 7 shows in a sectional view, an exemplary embodiment of a thermally soldered construction in the form of a heat exchanger.

### DETAILED DESCRIPTION OF THE INVENTION

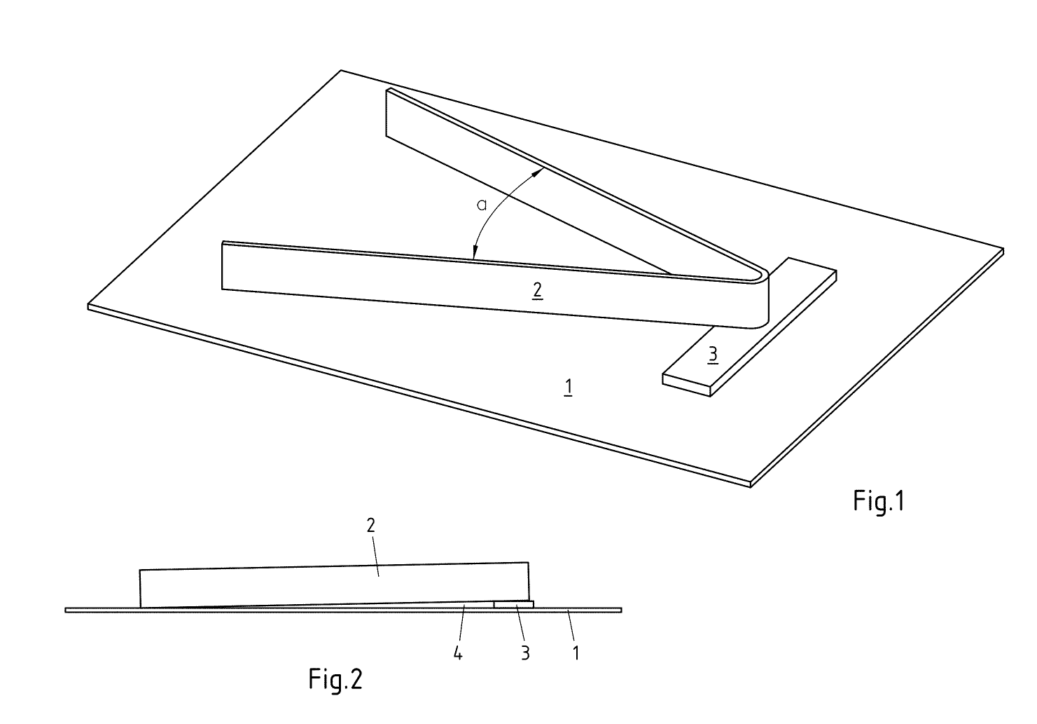

In order to examine the advantages of the aluminium composite material according to the invention, a number of tests have been carried out with a specified solder test arrangement, as is perspectively represented in FIG. 1. The solder test arrangement essentially consists of three parts in total, a sheet metal 1, an angular sheet metal 2 and a contact sheet metal 3 for the angular sheet metal 2. With its closed end 2a, the angular sheet metal 2 rests on the contact sheet metal 3 arranged on sheet metal 1. Both leg ends 2b, in contrast, rest on the sheet metal 1 such that, as represented in the side view in FIG. 2, a variable gap results from the contact point of the leg ends 2b of the angular sheet metal 2 to the contact point of the closed end 2a on the contact sheet metal 3. The solder gap 4 is increasingly larger from the angular ends 2b to the closed end 2a of the angular sheet metal. The increasing solder gap 4 means it can be determined to what extent the solder properties of the aluminium composite material of the sheet metal 1 are changed with different surface treatment.

In particular, the wetting of the provided solder gap is assessed in the solder results. In this case, the following assessments have been indicated,

⊗ very good
∘ good [symbol]
sufficient
∇ poor

The gap filling capacity together with the forms of the solder fillet being decisive for this. The tests, which showed a virtually complete inflow of the solder gap and a wide, smooth and pore-free solder fillet, were assessed with very good (⊗). The tests, which did not lead to soldering of the components, were assessed with poor (∇).

The sheet metal 1 consists, in the present exemplary embodiment, of the respective tested aluminium alloy composite material which comprises a roll-clad aluminium solder alloy layer. The lengths of the legs of the angle 2 were 50 mm, the opening angle of the angular sheet metal being 35°. The contact sheet metal 3 has a thickness of 1 mm such that the height difference from the closed end of the angular sheet metal to the leg end is 1 mm. The angular sheet metal 2 and the contact sheet metal 3 are not equipped with an aluminium solder layer.

Generally, the solderability is also always a function of the component design, for example geometry, gap size, etc., and also the furnace atmosphere in addition to the use of suitable solderable materials. The oxygen particle pressure and the moisture of the atmosphere play a role here. The represented solder tests in the CAB method have been carried out in a batch furnace under nitrogen flow. These solder results are comparable to those from industrial production using a continuous furnace.

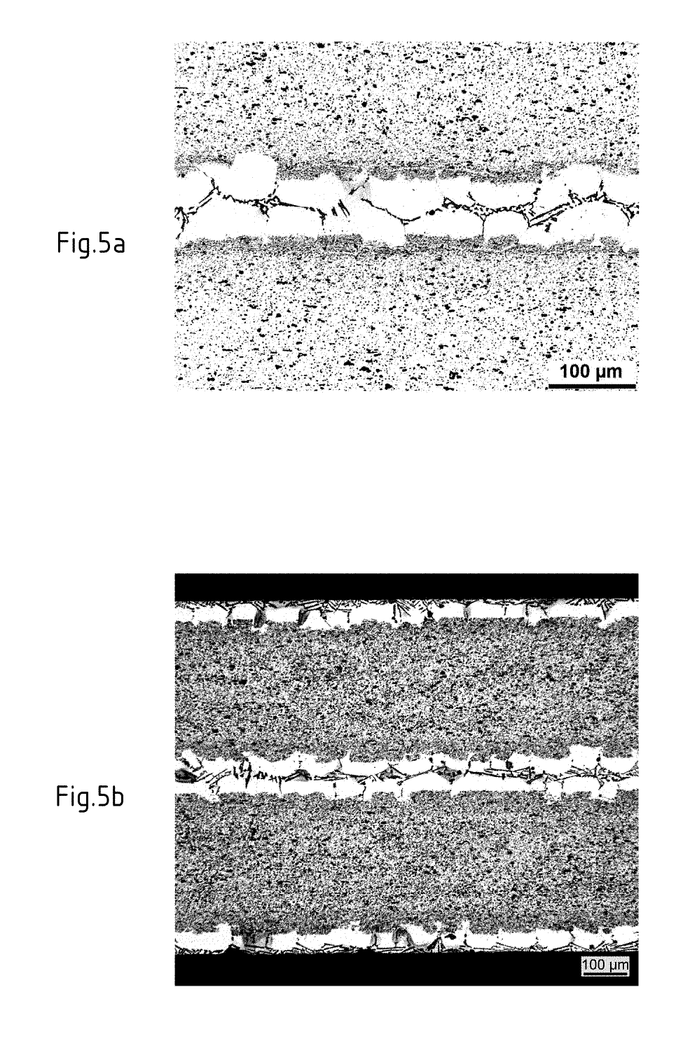

The tests results are described below based on the compilation of test runs. In this case, a test run in the CAB method with different Mg contents of aluminium solder alloy and aluminium core alloy with different surface treatments are recorded in Table 1. Solder results for different alloy combinations have also been examined in the second test run in the CAB method, the aluminium solder alloys in particular comprising Bi. The alloy combinations and results for the second test run are reflected in Tables 2 and 3. Table 4 and 5 show additional test results from the CAB method. Subsequently, results from the vacuum soldering method are presented in the description for Table 6 and FIG. 5a, b.

TABLE 1

| | | | | | | Solder |
|---|---|---|---|---|---|---|
| | | | | | | result |
| | | Mg | Mg | | Solder | alkaline |
| | | content | content | Solder | result | pickled, |
| | | solder | core | result | alkaline | fluoride- |
| | | layer | layer | acid | pickled, | containing |
| Sample | | (ppm) | (ppm) | pickled | deoxidized | deoxidation |
| A | Inv | 282 | 409 | ⊗ | ∘ | ⊗ |
| B | Comp | 79 | 192 | ∇ | [symbol] | [symbol] |
| C | Comp | 78 | 3 | ∇ | ∇ | [symbol] |
| D | Comp | 33 | 3 | ∇ | ∇ | ∇ |
| E | Comp | 46 | 1 | ∇ | [symbol] | [symbol] |
| F | Inv | 279 | 34 | ∘ | ∇ | ∘ |
| G | Comp | 181 | 12 | ∘ | [symbol] | ⊗ |
| H | Comp | 106 | 394 | ∘ | [symbol] | ⊗ |
| I | Comp | 33 | 9 | ∇ | ∘ | ∇ |
| J | Comp | 62 | 9 | ∇ | [symbol] | ∇ |
| K | Comp | 53 | 11 | ∇ | [symbol] | ∇ |
| L | Comp | 46 | 4 | ∇ | ∇ | ∇ |
| M | Comp | 181 | 9 | ∘ | [symbol] | ⊗ |
| N | Comp | 140 | 0 | ⊗ | ∘ | ∘ |
| O | Comp | 84 | 3 | ∇ | [symbol] | ∘ |

Table 1 shows a compilation of the solder results of the first test run, which have been measured with the described test structure. The used aluminium solder alloys meet the specifications of the type AA4045 in connection with the Mg contents indicated in Table 1 in ppm in relation to the weight. In order to examine an additional influence of the Mg content of the core layer, different aluminium core alloys of the type AA 3003, whose Mg content is recorded in Table 1, have also been used in 0.8 mm with 10% solder cladding. The solder capacity has been examined as a function of the Mg content in connection with three differently pickled surfaces, as are described below.

The acid pickled surface has been produced by pickling in the dip method. A mixture of surfactants, sulphuric acid and hydrofluoric acid has been used. The temperature of the solution was 60° C. The concentration of sulphuric acid was 2.5 wt %. 400 ppm of fluoride was also used in the pickling solution. The contact time was 60 seconds.

The alkaline pickled surface was produced by pickling in the spraying method. A mixture of a degreasing agent and caustic soda was used. The temperature of the solution was 60° C. 2% of an aqueous mixture of 5-40 wt % sodium tripolyphosphate, 3-10 wt % sodium gluconate, 3-8 wt % non-ionic and anionic surfactants were used as degreasing agents. The concentration of the caustic soda was 1% in total. The contact time was 30 seconds.

Following the alkaline spraying treatment, deoxidation by means of an acid rinse was applied. Deoxidation containing either 5% nitric acid or 5% nitric acid with 200 ppm fluoride was used as deoxidation.

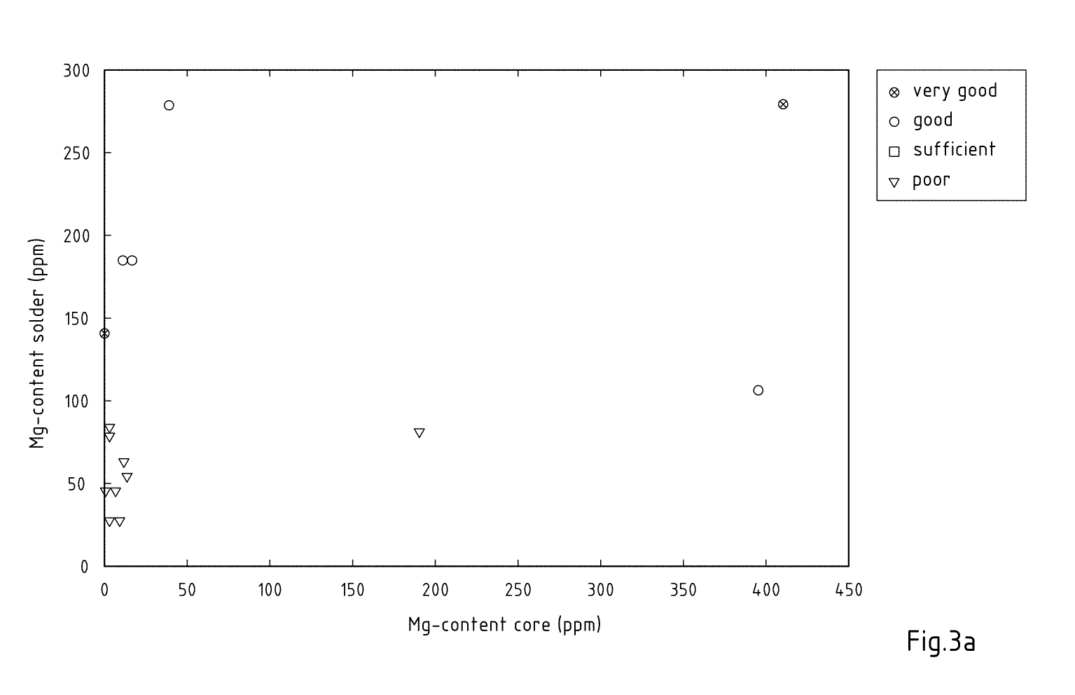

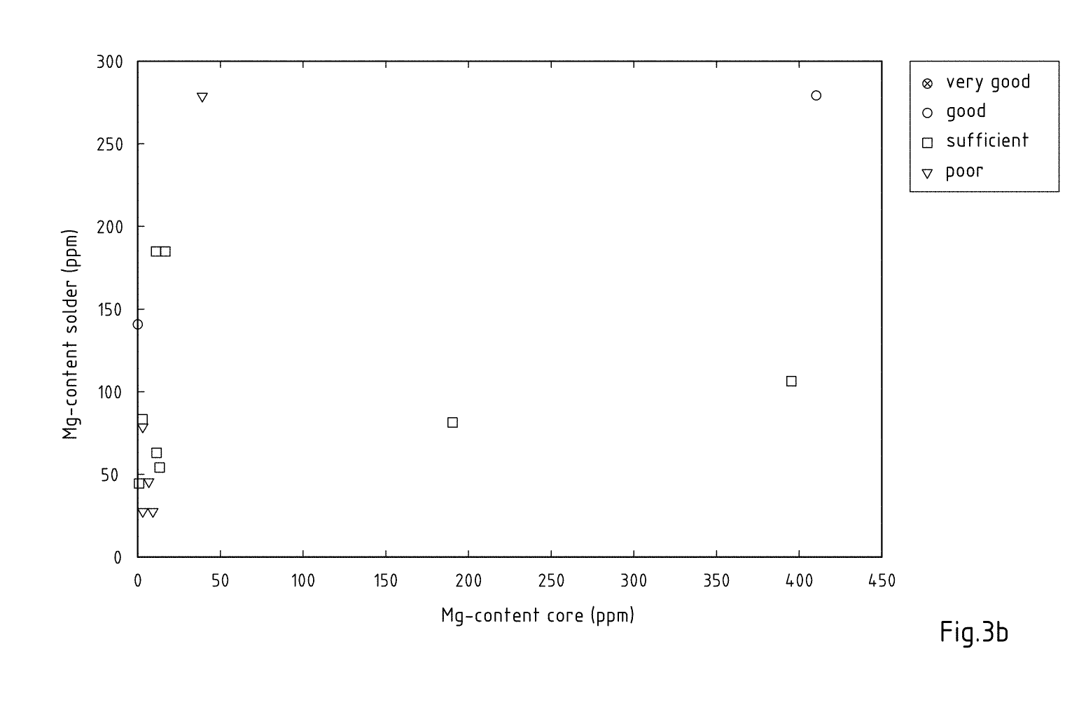

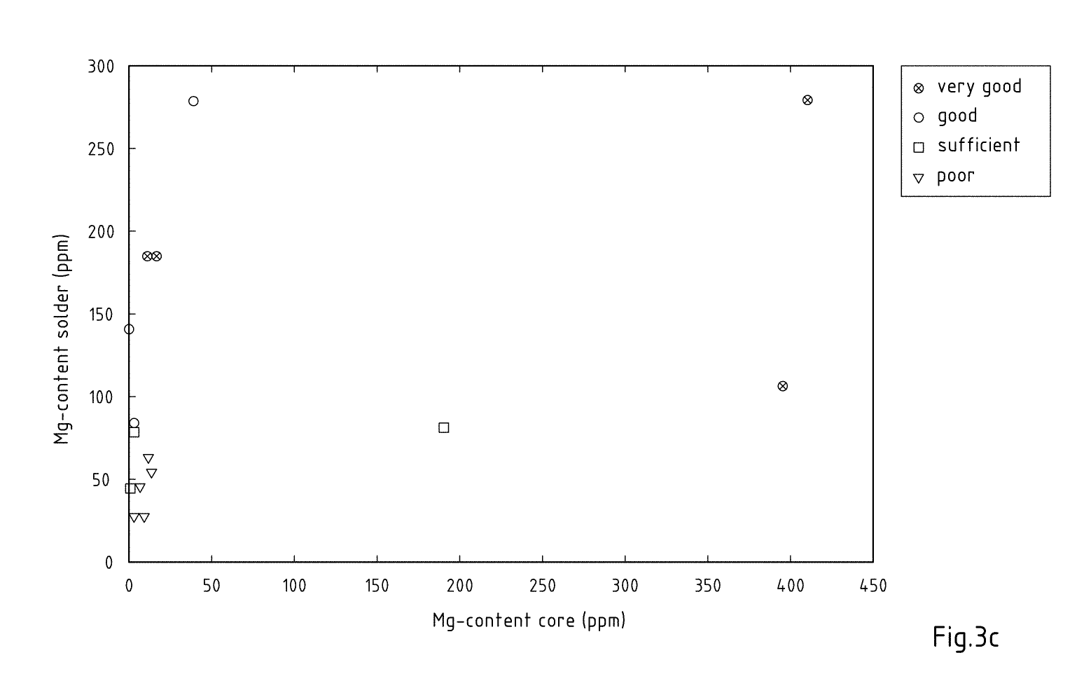

FIG. 3a-c show overview diagrams of the solder result of the exemplary embodiments of the aluminium composite material from Table 1 as a function of the Mg contents of the aluminium solder alloy and aluminium core alloy. FIG. 3a shows the aluminium composite materials with acid pickled surface, FIG. 3b the aluminium composite materials with alkaline pickled and deoxidized surface and FIG. 3c the aluminium composite materials with alkaline pickled surface deoxidized by adding fluorides.

A clear dependence of the solder result on the Mg content of the aluminium solder alloy can be recognised. Alloys with lower Mg contents below 90 ppm produce predominantly poor and merely sufficient solder results. Even though sufficient and good results are present in the range between 90 ppm and 300 ppm, a dependence of the results is to be expected on the absolute quantity of solder, the Mg content of the aluminium core alloy and the optional fluoride content in the pickle or in the deoxidation. For improved solder results even with different or low Mg contents of the aluminium core alloy and possibly even lower absolute quantities of the solder layer, the Mg content of the aluminium solder alloy is thus fixed at 230-450 ppm.

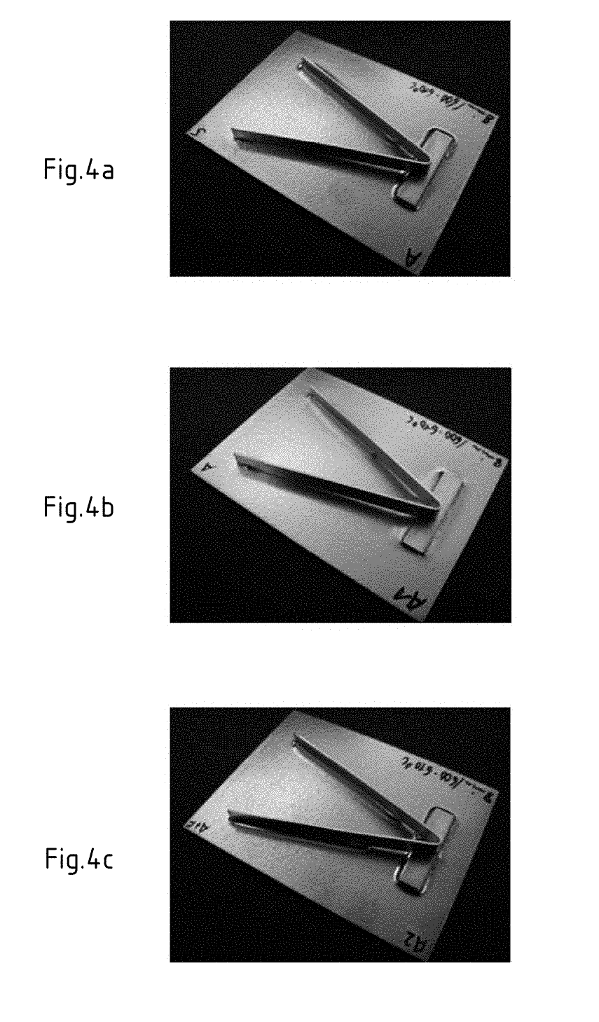

FIG. 4a-c show photos of the soldered exemplary embodiment N of the aluminium composite material from Table 1 with an Mg content of 282 ppm in the aluminium solder alloy. The good or very good solder results can be recognised for all surface treatments. In this case, FIG. 4a shows the acid pickled sample, FIG. 4b the alkaline pickled and deoxidized sample and FIG. 4c the alkaline pickled sample deoxidized by adding fluorides.

TABLE 2

| | Mg content | Bi content | Mg content | Cu content | Ti content |
|---|---|---|---|---|---|
| | solder | solder | core | core | core |
| | layer | layer | layer | layer | layer |
| Sample | (ppm) | (ppm) | (ppm) | (wt %) | (wt %) |
| V1 | 235 | <5 | <5 | 0.17 | 0.013 |
| V2 | 230 | 240 | <5 | 0.17 | 0.013 |
| V3 | 230 | 240 | 5 | 0.44 | 0.145 |
| V4 | 230 | 240 | 800 | 0.004 | 0.008 |
| V5 | 247 | 467 | <5 | 0.17 | 0.013 |

TABLE 3

| | | Results of slow soldering | | | Results of quick soldering | | | | | | | | |
|---|---|---|---|---|---|---|---|---|---|---|---|---|---|
| | Thickness | | Alkaline | Acid | | Alkaline pickled | | | | Acid pickled | | | |
| Sample | (mm) | Untreated | pickled | pickled | Untreated | 10 s | 20 s | 30 s | 60 s | 10 s | 15 s | 30 s | 60 s |
| V1 | 0.4 | ∇ | ∘ | ∘ | ∇ | ∘ | ∘ | ∘ | ∘ | □ | ∘ | ∘ | ∘ |
| | 1.5 | ∇ | □ | ⊗ | ∇ | ∘ | ⊗ | ⊗ | ⊗ | ∘ | ⊗ | ⊗ | ⊗ |
| V2 | 0.4 | □ | □ | ∇ | ∇ | ∇ | □ | □ | □ | ∇ | ∇ | □ | □ |
| | 1.5 | ∇ | ∘ | □ | □ | ∘ | ∘ | ∘ | ∘ | ∇ | ∇ | □ | ⊗ |
| V3 | 0.4 | ∇ | □ | ∇ | ∇ | ∇ | □ | □ | □ | ∇ | □ | ∇ | ∇ |
| | 1.5 | ∘ | ⊗ | ∇ | ∘ | ∘ | ⊗ | ⊗ | ⊗ | ∇ | □ | ∇ | □ |
| V4 | 0.4 | ∘ | ⊗ | ⊗ | ∘ | ∘ | ⊗ | ⊗ | ⊗ | □ | ∘ | ⊗ | ⊗ |
| | 1.5 | ⊗ | ⊗ | ⊗ | ∘ | ∘ | ⊗ | ⊗ | ⊗ | □ | □ | ⊗ | ⊗ |
| V5 | 0.4 | □ | ∘ | □ | ∇ | ∇ | ∘ | ∘ | ∘ | ∇ | □ | □ | □ |
| | 1.5 | ∘ | ⊗ | ∇ | ∇ | □ | ⊗ | ⊗ | ⊗ | ∇ | □ | □ | □ |

Tables 2 and 3 show the compilation of the solder results of the second test run which has been measured with the described test structure. In this case, the alloy compositions of the aluminium solder alloy corresponded to type AA 4045 and those of the aluminium core alloy to the type AA 3xxx, aside from possible deviations in the concentrations for Mg, Bi, Cu and Ti, as they are indicated in Table 2. The core alloy of the tests V1, V2 and V5 corresponds to the specifications of the type AA 3003. The core alloy of the test V3 corresponds to a modified type AA 3017 with the Cu content and Ti content indicated in Table 2. For test V4, a core alloy with a modified type AA 3003 has been used with the additional Mg content indicated in Table 2.

The thermal joining method has been carried out in a batch furnace under protective gas with two different soldering cycles: “slow soldering” over a soldering cycle with an approx. 20 minute heating curve and a holding time between 600° C. and 610° C. of 8 mins for a sample thickness of 0.4 mm or of 10 mins for a sample thickness of 1.5 mm. The “slow” heating curve has been achieved by the sample being inserted at a furnace temperature of 400° C. into the batch furnace and then heated to the soldering temperature. An even shorter soldering cycle is used in the “quick soldering”, the sample being inserted into the already hot furnace, which was heated to the soldering temperature. The heating curve up to achieving the soldering temperature lasted, in this case, only 4 to at most 8 minutes. The holding time at 600° C. was 8 mins for a sample thickness of 0.4 mm or over 10 mins for a sample thickness of 1.5 mm. The indicated temperatures have been measured on a steel sample holder, on which the aluminium sample rested.

The thickness of the sample is the average thickness of the entire sheet metal or aluminium composite material; the average thickness of the solder layer was 7.5% of the indicated average thickness of the entire aluminium composite material.

The contact time of the samples in the pickle in the tests with slow soldering was 20 seconds for the alkaline treatment and 30 seconds for the acid treatment. In addition to the different alloy combinations, the contact time for the alkaline pickling and the acid pickling were varied for the quick soldering. The contact time is noted in Table 3 with 10, 15 or 20, 30 and 60 seconds. Untreated samples, which are not surface-conditioned further, have also been examined as a comparison.

Initially, it can be determined based on the results from Table 3 that the untreated samples deliver predominately poor or only sufficient solder results. By means of an alkaline or acid treatment of the surface, the solder result for most of the samples is decidedly improved. Of the untreated samples, only V4 shows very good results. The aluminium core alloy of sample V4 has a high Mg content of 800 ppm which improves the solder result.

It also seems to emerge from a comparison of the results for the different sample thicknesses that the thicker samples with 1.5 mm thickness in general solder better than the thinner samples with 0.4 mm thickness. However, this also relates to the fact that the thicker samples with the same relative solder proportion have a greater absolute thickness of the solder layer and thus a greater absolute quantity of aluminium solder alloy. Irrespective of the thickness of the sample, it can be stated that the alkaline or acid treatment of the surface decidedly improves the solder result for most samples.

For example, it can be concluded from a comparison of the samples V1, V2 and V5 that Bi in the aluminium solder alloy has a positive influence on the solder result. It is shown that in combination with the specific Mg content of the aluminium solder alloy and the alkaline or acid treatment of the surface even a Bi content of less than 500 ppm, preferably at most 280 ppm has a notable positive effect on the solder result. In particular, the ranges of 100 ppm-280 ppm and 200 ppm-280 ppm are mentioned as advantageous. Corresponding Bi contents are already sufficient to largely optimise the solder properties of the aluminium composite material without larger quantities of Bi having to be added.

It has also been shown for the samples V2 to V5 that, for the minimum contents of Bi, an alkaline pickled surface leads to notably improved solder results or even requires shorter contact times than with an acid treatment. The advantageous effect of Bi in the aluminium solder alloy is thus supported in a particular manner by an alkaline pickled surface.

In the tests, the contact time of the aluminium composite material in the pickling solution is preferably 10-40 seconds. For an alkaline pickling, the contact time is further preferably 10-30 seconds since, as is discernible from Table 2, the solder result does not develop significantly further with higher contact times. For an acid pickling, the contact time is further preferably 20-40 second, for samples with a Bi content from 100 ppm or 200 ppm a dip time for the acid treatment of more than 40 seconds is advantageous. For the production, in particular using spraying methods for pickling, contact times of in particular 1-60 seconds, preferably 2-40 seconds, further preferably 2-20 second are envisaged.

Table 4 and 5 show further solder results from the CAB method using the aluminium composite material.

TABLE 4

| | Si | Fe | Cu | Mn | Mg | Cr | Ni | Zn | Ti | Bi |
|---|---|---|---|---|---|---|---|---|---|---|
| Core | 0.0460 | 0.1976 | 0.4467 | 1.0908 | 0.1449 | 0.0696 | | 0.0190 | 0.0265 | |
| Solder | 10.0435 | 0.1774 | 0.0035 | 0.0128 | 0.0360 | 0.0012 | 0.0050 | 0.0025 | 0.0099 | 0.0420 |

TABLE 5

| Thickness | | Alkaline | Alkaline | Alkaline | Acid | Acid | Acid |
|---|---|---|---|---|---|---|---|
| (mm) | Untreated | treatment 1 | treatment 2 | treatment 3 | pickled 60 sec | pickled 10 sec | pickled 20 sec |
| 0.63 | + | ⊗ | ⊗ | ⊗ | ⊗ | ⊗ | ⊗ |
| 1.20 | + | ⊗ | ⊗ | ⊗ | ⊗ | ⊗ | ⊗ |

The indicated thickness corresponds to the entire thickness of the aluminium composite material. The samples were inserted into the hot batch furnace and were at the solder temperature within 4 to 8 minutes. The nitrogen flow was 30 I/min. The samples with 0.63 mm thickness were soldered with a holding time of 8 mins at 600-610° C. The samples with 1.20 mm thickness were soldered with a holding time of 10 mins at 600-610° C. The samples marked as untreated were soldered as comparative samples in the delivery state of the rolling mill.

For the three alkaline treatments, the aluminium composite material was treated for 30 seconds with a pickle comprising the following constituents: at least 0.5-3 wt % of an aqueous mixture of 5-40 wt % sodium tripolyphosphate, 3-10 wt % sodium gluconate, 3-8 wt % non-ionic and anionic surfactants, optionally 0.5-70 wt % sodium carbonate with the addition of NaOH, the caustic soda concentration in the pickling solution being 1 wt % in total.

Following the alkaline treatment 1, deoxidation was carried out for 30 seconds with an HNO₃ solution with a concentration of 2.5 wt %. Following the alkaline treatment 2, deoxidation was carried out for 30 seconds with an HNO₃ solution with a concentration of 2.5 wt %, with the addition of 500 ppm F. For the alkaline treatment 3, in contrast, deoxidation was carried out for 15 seconds with an acid mixture of 2.5 wt % H₂SO₄ and 400 ppm HF and optionally surfactants.

The results from Table 5 show that the above-described combination of the conditioned surface and the specific composition of the aluminium solder alloy, in particular the balanced Mg content, enables very good solder results in flux-free protective gas soldering.

The test results from Table 5 were also reproduced to the extent of an industrial scale production. The material indicated in Table 4 with a total thickness of 0.63 mm was subjected to the above-described alkaline treatment 2, except that 600 ppm fluoride and a contact time of 8 seconds were provided. The material indicated in Table 4 with a total thickness of 1.2 mm was also tested on an industrial scale, the above-described acid treatment with the addition of 800 ppm fluoride was applied with a contact time of 6 seconds. Subsequent solder tests in the laboratory showed very good solder results for both thicknesses and treatments.

In order to demonstrate the solder capacity of the aluminium composite material in different solder methods, solder tests were also carried out in a vacuum. Flat samples of the aluminium composite material with the solder layers were placed on top of each other and joined. FIGS. 5a and 5b shows metallographic cuts through the solder points resulting in the vacuum method.

The composition of aluminium core alloy and aluminium solder alloy from the test in FIG. 5a is the composition already indicated in Table 4. The aluminium composite material has a thickness of 0.63 mm and was conditioned with the above-described alkaline treatment 2 with fluorides in the deoxidation. As can be recognised from the microstructure in FIG. 5a, a virtually complete material bond has developed during soldering. The solder result is assessed as very good. It is thus clear that the aluminium composite material shows very good solder quality both in vacuum soldering and in the flux-free CAB method and can be reliably joined.

FIG. 5b shows a further test result of a connection produced by means of vacuum soldering. The composition of aluminium core alloy and aluminium solder alloy are indicated in Table 6 in wt %.

TABLE 6

| | Si | Fe | Cu | Mn | Mg | Cr | Ni | Zn | Ti |
|---|---|---|---|---|---|---|---|---|---|
| Core | 0.1382 | 0.3182 | 0.4294 | 1.1446 | 0.0022 | 0.0007 | 0.004 | 0.0025 | 0.1361 |
| Solder | 9.9562 | 0.1744 | 0.002 | 0.0087 | 0.0294 | 0.0013 | 0.0032 | 0.0136 | 0.0102 |

The core layer had a thickness of 0.42 mm and was in the state 0. The aluminium composite material was treated with an alkaline pickle comprising the following constituents:

At least 0.5-3 wt % of an aqueous mixture of 5-40 wt % sodium tripolyphosphate, 3-10 wt % sodium gluconate, 3-8 wt % non-ionic and anionic surfactants, optionally 0.5-70 wt % sodium carbonate, with the addition of NaOH, the caustic soda concentration in the pickling solution being in total 1 wt %. Following the pickle, deoxidation was carried out in an HNO₃ solution with a concentration of 2.5 wt %, adding 400-600 ppm fluoride.

The aluminium solder alloy from FIG. 5b or Table 6 contains virtually no Bi. The solder capacity is thus effected in particular by the combination of the surface treatment with the composition of the alloys, in particular the specifically set Mg content of the aluminium solder alloy. The solder result from FIG. 5b is also assessed as very good.

Contrary to the expectation among experts, it is surprisingly possible, by combining the alkaline or acid pickle with the specific composition of the aluminium composite material, to join aluminium composite materials thermally in a vacuum without solders with more than 1% Mg having to be used.

In a synopsis with the results from the CAB method explained above concerning Table 1 to 5, it becomes clear that using the described aluminium composite material, process-reliable soldering is enabled in the different soldering methods, in particular both in the CAB method and in vacuum soldering.

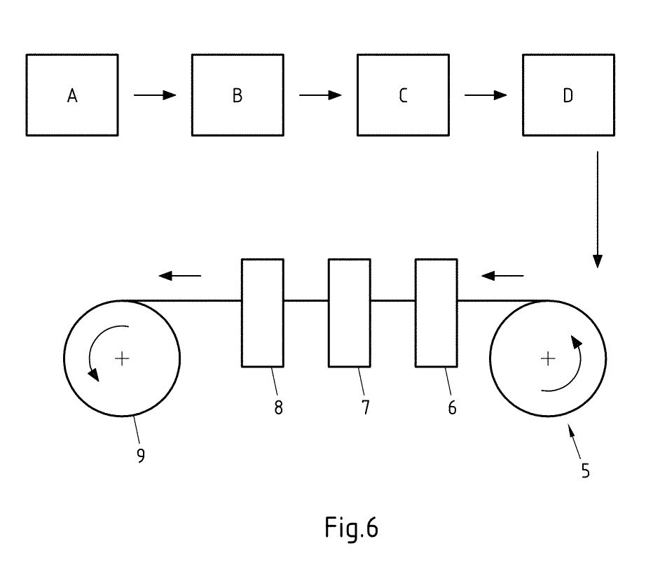

An exemplary embodiment for a method for producing a strip-shaped aluminium composite material is represented in FIG. 6. In the manufacturing step A, the aluminium composite material is manufactured by simultaneous casting of different melts or by roll cladding. Subsequently, cold rolling B to final thickness is for example carried out, wherein at least intermediate annealing can take place during the cold rolling. Subsequently, the aluminium composite material is for example soft-annealed in the method step C. At least the aluminium solder alloy layer is subjected to surface treatment in method step D. Method step D is subsequently represented for a strip-shaped aluminium composite material.

The aluminium composite material located on a coil 5 is optionally subjected to a degreasing step 6. Subsequently, the aluminium composite material passes through the pickling step 7 in which it is for example guided through a bath with an aqueous acid pickling solution which has a complexing agent, in addition to an acid such that material erosion takes place on the aluminium solder alloy surface. The bath preferably consists of an aqueous sulphuric acid with 0.1%-20%, optionally at least one surfactant and one HF content of 20 ppm-600 ppm, preferably 300 ppm-600 ppm or 300 ppm-480 ppm.

Following a rinsing and drying step 8, the surface-treated aluminium composite material is wound to a coil 9. The described surface treatment step D can, however, also take place in a non-strip shaped manner or directly at the outlet of the production process, i.e. of the cold rolling or for example soft-annealing, provided a continuous furnace is used for this purpose.

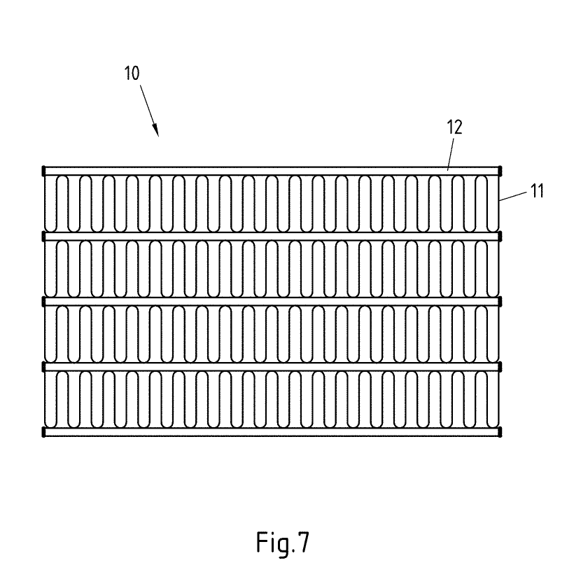

An exemplary embodiment of a thermally joined construction is represented in FIG. 7 in plan view in the shape of a heat exchanger 10.

The fins 11 of the heat exchanger 10 usually consists of blank aluminium alloy strip or aluminium alloy strip coated on both side with an aluminium solder. The fins 11 are soldered to pipes 12 bent in a meandering shape such that a plurality of solder connection is required. It is thus particularly advantageous to use the aluminium composite material according to the invention since the particularly good solder results are achieved in the CAB method even without fluxing agents. The absent fluxing agent residues have a positive effect on the operation of the heat exchangers in comparison to heat exchangers soldered with fluxing agents.

The test results in particular showed that an aluminium composite material, which has a pickled surface of an aluminium solder alloy layer in connection with a specific Mg content, has very good properties with regard to its solder capacity in a flux-free joining thermal method carried out under protective gas, for example a CAB method and in thermal joining in a vacuum. Using the described aluminium composite material, it is thus possible to further optimise the solder properties without the use of fluxing agents while avoiding the disadvantages known from the prior art and to also reliably carry out different soldering methods with the same type of aluminium composite material.

All concentration information in the description, unless otherwise explicitly indicated, relates to the weight.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. An aluminium composite material for use in thermal flux-free joining methods, comprising
at least one core layer consisting of an aluminium core alloy; and
at least one outer solder layer provided on one or both sides of the core layer consisting of an aluminium solder alloy;
wherein the aluminium solder alloy has the following composition in wt %:
6.5%≤Si≤13%,
Fe≤1%,
230 ppm≤Mg≤450 ppm,
Bi<500 ppm,
Mn≤0.15%,
Cu≤0.3%,
Zn≤3%,
Ti≤0.30%,
Remainder Al and unavoidable impurities individually at most 0.05%, in total at most 0.15%; and
wherein the aluminium solder layer has an alkaline pickled or acid pickled surface.

2. The aluminium composite material according to claim 1, wherein the aluminium solder alloy has an Mg content in wt % of
230 ppm≤Mg≤400 ppm

3. The aluminium composite material according to claim 1, wherein the aluminium solder alloy has a Bi content in wt % of
Bi≤280 ppm

4. The aluminium composite material according to claim 1, wherein the aluminium solder alloy meets the specifications of type AA 4045 or type AA 4343.

5. The aluminium composite material according to claim 1, wherein the aluminium solder alloy has an Mg content of at most 1.0 wt %, preferably 0.2%-0.6%, 0.05%-0.30% or less than 0.05 wt %.

6. The aluminium composite material according to claim 1, characterised in that the aluminium core alloy is an alloy of type AA3xxx, preferably of the type AA3003, of the type AA3005, or of the type AA3017 or the type AA6xxx, preferably of the type AA6063 or the type AA6060.

7. The aluminium composite material according to claim 1, wherein the average thickness of the aluminium composite material is from 0.05-6 mm, preferably from 0.2-3 mm.

8. A method for producing an aluminium composite material, in particular an aluminium composite material according to claim 1, the method comprising the steps of:
providing at least one core layer consisting of an aluminium core alloy; and
applying at least one outer solder layer consisting of an aluminium solder alloy on one or both sides of the core layer;
wherein the aluminium solder alloy has the following composition in wt %:
6.5%≤Si≤13%,
Fe≤1%,
230 ppm≤Mg≤450 ppm,
Bi<500 ppm,
Mn≤0.15%,
Cu≤0.3%,
Zn≤3%,
Ti≤0.30%,
Remainder Al and unavoidable impurities individually at most 0.05%, in total at most 0.15% and
wherein the aluminium composite material is pickled with an aqueous, alkaline or acid pickling solution.

9. A method according to claim 8, wherein an acid, aqueous pickling solution is used containing:
at least one mineral acid and at least one complexing agent or at least one acid of the group of short-chain carboxylic acids and at least one complexing agent; or
at least one complexing acid.

10. A method according to claim 9, wherein the concentrations of the mineral acids in the pickling solution have the following limits:
H₂SO₄: 0.1%-20 wt %,
H₃PO₄: 0.1%-20 wt %,
HCl: 0.1%-10 wt %,
HF: 20 ppm-3.0 wt %,
and optionally at least one surfactant is contained in the pickling solution.

11. A method according to claim 8, wherein an alkaline pickling solution is used containing 0.01-5 wt % NaOH, which optionally has at least 0.5-3 wt % of an aqueous mixture of 5-40 wt % sodium tripolyphosphate, 3-10 wt % sodium gluconate, 3-8 wt % non-ionic and anionic surfactants, optionally 0.5-70 wt % sodium carbonate.

12. A method for thermally joining components, comprising the step of thermally joining at least one component comprising an aluminium composite material according to claim 1 to at least one additional component in a flux-free manner.

13. A method according to claim 12, wherein the flux-free thermal joining is carried out in a vacuum, in particular with a maximum pressure of 10⁻⁵ mbar.

14. A method according to claim 12, wherein the flux-free thermal joining is carried out in a protective gas atmosphere.

15. A thermally joined construction comprising
at least one component comprising an aluminium composite material according to claim 1; and
at least one additional component which in particular comprises aluminium or an aluminium alloy.
